(19) United States
(12) Patent Application Publication
(10) Pub. No.: US 2021/0182819 A1
(43) Pub. Date: Jun. 17, 2021

(54) TRANSACTION PROCESSING SYSTEM

(71) Applicant: TOSHIBA TEC KABUSHIKI KAISHA, Tokyo (JP)

(72) Inventor: Kentaro HAMADA, Izunokuni Shizuoka (JP)

(73) Assignee: TOSHIBA TEC KABUSHIKI KAISHA, Tokyo (JP)

(21) Appl. No.: 16/987,152

(22) Filed: Aug. 6, 2020

(30) Foreign Application Priority Data
Dec. 17, 2019 (JP) 2019-227132

(51) Int. Cl. G06Q 20/20; G06F 16/23

(52) U.S. Cl. CPC G06Q 20/202; G06Q 30/0281; G06F 16/2379

(57) ABSTRACT

A transaction processing system includes first and second apparatuses and processes a transaction with a customer in a store. The transaction processing system includes a first input unit provided in the first apparatus, a second input unit provided in the second apparatus, a processing unit, and a display unit provided in the first apparatus. The first input unit inputs an instruction by the customer. The second input unit inputs an instruction by a store clerk in the store. The processing unit executes information processing for processing the transaction according to the instruction input by the first or second input unit. The display unit is provided in the first apparatus and, if the processing unit executes the information processing according to the instruction input by the second input unit, displays an operation performed by the store clerk when inputting the instruction with the second input unit.

### CROSS-REFERENCE TO RELATED APPLICATION

This application is based upon and claims the benefit of priority from Japanese Patent Application No. 2019-227132, filed Dec. 17, 2019, the entire contents of which are incorporated herein by reference.

### FIELD

Embodiments described herein relate generally to a transaction processing system.

### BACKGROUND

In recent years, a self-service for causing a customer to perform an instruction concerning various kinds of information processing relating to transaction processing has been actively performed for labor saving in a store.

For example, a system for performing, according to an instruction of a customer by operation of an information terminal carried by the customer, information processing relating to registration to settlement of purchased commodities called a smartphone POS (point-of-sale) system or the like has been developed.

Related art is described in, for example, JP-A-2019-133716.

### BRIEF DESCRIPTION OF THE DRAWINGS

FIG. 1 is a block diagram illustrating a schematic configuration of a transaction processing system according to at least one embodiment;

FIG. 2 is a block diagram illustrating a main part circuit configuration of a store server illustrated in FIG. 1;

FIG. 3 is a block diagram illustrating a main part circuit configuration of a virtual POS server illustrated in FIG. 1;

FIG. 4 is a block diagram illustrating a main part circuit configuration of a mobile controller illustrated in FIG. 1;

FIG. 5 is a block diagram illustrating a main part circuit configuration of a customer terminal illustrated in FIG. 1;

FIG. 6 is a block diagram illustrating a main part circuit configuration of a store clerk terminal illustrated in FIG. 1;

FIG. 7 is a flowchart of information processing based on a store clerk terminal application by a processor illustrated in FIG. 6;

FIG. 8 is a flowchart of the information processing based on the store clerk terminal application by the processor illustrated in FIG. 6;

FIG. 9 is a flowchart of information processing based on a substitution application by a processor illustrated in FIG. 7;

FIG. 10 is a diagram illustrating an example of an input screen;

FIG. 11 is a diagram illustrating an example of a confirmation screen;

FIG. 12 is a diagram illustrating an example of a selection screen;

FIG. 13 is a diagram illustrating an example of an in-substitution screen; and

FIG. 14 is a diagram illustrating an example of a guidance screen.

### DETAILED DESCRIPTION

In some POS systems, it may be difficult for all customers to perform, however, without a mistake, all kinds of operation that the customers should perform. Therefore, it is desirable that a store clerk in a store can support apart of the operation. Accordingly, it is conceivable that the store clerk performs, through a remote operation, substituting for the customer, an instruction that the customer should perform. In this case, however, it may be difficult for the customer to confirm what kind of operation the customer should perform.

Under such circumstances, if the store clerk performs, substituting for the customer, an instruction that the customer should perform, it is desired to make it possible to cause the customer to confirm the operation for the instruction.

An object of at least one embodiment is to provide a transaction processing system that can cause, if a store clerk performs, substituting for a customer, an instruction that the customer should perform, the customer to confirm operation for the instruction.

According to at least one embodiment, there is provided a transaction processing system that includes a first apparatus and a second apparatus and processes a transaction with a customer in a store, the transaction processing system including: a first input unit provided in the first apparatus; a second input unit provided in the second apparatus; a processing unit; and a display unit provided in the first apparatus. The first input unit inputs an instruction by the customer. The second input unit inputs an instruction by a store clerk in the store. The processing unit executes information processing for processing the transaction according to the instruction input by the first input unit or the second input unit. The display unit is provided in the first apparatus and, if the processing unit executes the information processing according to the instruction input by the second input unit, displays operation performed by the store clerk when inputting the instruction with the second input unit.

A transaction processing system according to an embodiment is explained below with reference to the drawings.

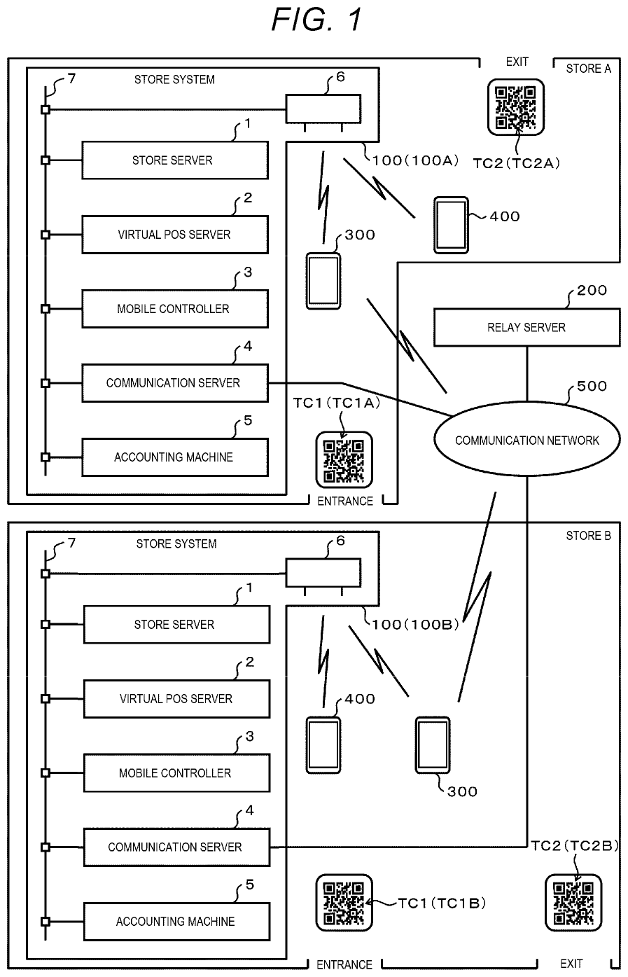

FIG. 1 is a block diagram illustrating a schematic configuration of the transaction processing system according to at least one embodiment.

The transaction processing system includes store systems 100, a relay server 200, customer terminals 300, and store clerk terminals 400. The store systems 100, the relay server 200, and the customer terminals 300 are communicably connected via a communication network 500.

In FIG. 1, two store systems 100 are illustrated. These store systems 100 are respectively provided in a store A and a store B different from each other that use the transaction processing system. Three or more stores that use the transaction processing system may be present. The store systems 100 are provided in each of the stores. In the following explanation, if it is necessary to distinguish the store systems 100 provided in the stores, the store system 100 provided in the store A is represented as a store system 100A and the store system 100 provided in the store B is represented as a store system 100B.

A company that operates the store A may be the same as or may be different from a company that operates the store B. If a transaction system is used in another store, a company that operates the store may be the same as or may be different from the company that operates the store A or the store B.

The relay server 200 relays data communication between the customer terminals 300 and the store systems 100. The relay server 200 provides, for example, a relay function for the data communication as a cloud service via the communication network 500.

The customer terminals 300 are terminal apparatuses functioning as user interfaces for customers who do shopping in the stores using the transaction system. The customer terminals 300 have a function of wirelessly communicating with the store systems 100 and a function of wirelessly communicating with the communication network 500. The customer terminals 300 may be carried by customers or may be lent to the customers in the stores.

The store clerk terminals 400 are terminal apparatuses functioning as user interfaces for store clerks in the stores including the store systems 100. The store clerk terminals 400 have a function of wirelessly communicating with the store systems 100. Only one store clerk terminal 400 may be provided or a plurality of store clerk terminals 400 may be provided for one store system 100.

As the communication network 500, for example, the Internet, a VPN (virtual private network), a LAN (local area network), a public communication network, and a mobile communication network can be used alone or can be combined and used as appropriate. As the communication network 500, typically, the mobile communication network and the Internet or the VPN are used.

A schematic configuration of the store systems 100 are common. That is, each of the store systems 100 is configured by communicably connecting a store server 1, a virtual POS server 2, a mobile controller 3, a communication server 4, an accounting machine 5, and an access point 6 via an intra-store communication network 7. However, the store server 1, the virtual POS server 2, the mobile controller 3, the communication server 4, the accounting machine 5, the access point 6, and the intra-communication network 7 only have to be common in a function for realizing operation explained below and do not need to be completely the same. A part of the store systems 100 may include apparatuses not illustrate in FIG. 1.

The store server 1 comprehensively manages a plurality of transactions set as targets of transaction processing realized by the store system 100 as explained below. The store server 1 has, for example, the same functions as functions of an existing POS server.

The virtual POS server 2 performs information processing for registration of purchased commodities, settlement of a price for the purchased commodities, and the like in each of transactions according to a request from the outside. That is, the virtual POS server 2 virtually realizes the functions of the existing POS server. However, the virtual POS server 2 does not perform an input of an instruction by the customer or the store clerk. The information processing performed by the virtual POS server 2 is customized to be adapted to a difference in an operation policy of each of the stores. That is, for example, information processing performed by the store server 1 included in the store system 100A and information processing performed by the store server 1 included in the store system 100B are sometimes partially different. The virtual POS server 2 is an example of a transaction processing apparatus.

The mobile controller 3 performs support for causing the virtual POS server 2 to perform the information processing explained above using the customer terminal 300 as a user interface device.

The communication server 4 performs communication processing for the store server 1, the virtual POS server 2, the mobile controller 3, and the accounting machine 5 to exchange data with the relay server 200 and the like via the communication network 500.

The accounting machine 5 performs processing for calculating prices for purchased commodities in each of transactions managed by the virtual POS server 2 and causing a customer to settle the prices. A settlement method that can be used by the accounting machine 5 for the settlement may be all or any part of well-known settlement methods such as cash settlement, credit card settlement, electronic money settlement, point settlement, and code settlement (also called mobile settlement or smartphone settlement). The accounting machine 5 may be operated by either a store clerk or a customer. As the accounting machine 5, for example, a self-service accounting machine used in an existing semi-self-service POS system can be used. The accounting machine 5 may have a function of performing information processing for registering a commodity as a purchased commodity. In this case, as the accounting machine 5, for example, a facing-type POS terminal used in an existing POS system or a self-service POS terminal used in an existing self-service POS system can be used.

The access point 6 performs communication processing for enabling the customer terminal 300 and the store clerk terminal 400 to access the intra-store communication network 7 through wireless communication. As the access point 6, for example, a well-known communication device that performs wireless communication according to the IEEE 801.11 standard can be used. The access point 6 is set in the store to enable the customer terminal 300 and the store clerk terminal 400 to wirelessly communicate with the access point 6 from anywhere in a selling space of the store. Depending on a store size, a plurality of access points 6 are disposed in one store system 100.

As the intra-store communication network 7, the Internet, a VPN, a LAN, a public communication network, a mobile communication network, and the like can be used alone or can be combined and used as appropriate. However, typically, the intra-store communication network 7 is a LAN.

In the store in which the store system 100 is provided, a two-dimensional code TC1 for check-in is posted near an entrance of the store and a two-dimensional code TC2 for check-out is posted near an exit of the store. The two-dimensional code TC1 represents check-in data for check-in. The two-dimensional code TC2 represents check-out data for check-out. The check-in data and the check-out data are different for each of the stores. Accordingly, if it is necessary to distinguish the two-dimensional codes TC1 and TC2 for the store A and the two-dimensional codes TC1 and TC2 for the store B, the two-dimensional codes TC1 and TC2 for the store A are represented as two-dimensional codes TC1A and TC2A and the two-dimensional codes TC1 and TC2 for the store B are represented as two-dimensional codes TC1B and TC2B.

The check-in data represents, for example, information explained below.

(1) An operation version of the store system 100. For example, check-in data represented by the two-dimensional code TC1A represents an operation version of the store system 100A. Check-in data represented by the two-dimensional code TC1B represents an operation version of the store system 100B.

(2) A company code for identifying a company that operates the store in which the store system 100 is provided. For example, the check-in data represented by the two-dimensional code TC1A represents a company code allocated to a company that operates the store A. The check-in data represented by the two-dimensional code TC1B represents a company code allocated to a company that operates the store B.

(3) A store code for identifying the store in which the store system 100 is provided. For example, the check-in data represented by the two-dimensional code TC1A represents a store code allocated to the store A. The check-in data represented by the two-dimensional code TC1B represents a store code allocated to the store B. The store code may be a store code capable of identifying each of all of the stores that use the transaction processing system or may be a store code capable of identifying each of a plurality of stores operated by the same company.

(4) A name of the company that operates the store in which the store system 100 may be provided. For example, the check-in data represented by the two-dimensional code TC1A represents a name of the company that operates the store A. The check-in data represented by the two-dimensional code TC1B represents a name of the company that operates the store B.

(5) A name of the store in which the store system 100 is provided. For example, the check-in data represented by the two-dimensional code TC1A represents a name of the store A. The check-in data represented by the two-dimensional code TC1B represents a name of the store B.

(6) A flag for distinguishing the two-dimensional code TC1 and the two-dimensional code TC2. The flag in the check-in data is set in a state representing the check-in data. The state is, for example, “1”. The flag is common to all the two-dimensional codes TC1.

(7) An IP address of the communication server 4. For example, the check-in data represented by the two-dimensional code TC1A represents an IP address of the communication server included in the store system 100A. The check-in data represented by the two-dimensional code TC1B represents an IP address of the communication server 4 included in the store system 100B.

(8) A domain name of the relay server 200. The domain name is common to all the two-dimensional codes TC1. However, a plurality of relay servers 200 having different domain names one another may be properly used for each of the stores. In this case, the check-in data represented by the two-dimensional code TC1 represents a domain name of the relay server 200 used in a store corresponding to the check-in data.

(9) An address of an electronic receipt server. The electronic receipt server is not included in the transaction processing system illustrated in FIG. 1. The electronic receipt server provides an electronic receipt service via the communication network 500. For example, the check-in data represented by the two-dimensional code TC1A represents an address for accessing, via the communication network 500, the electronic receipt server that provides the electronic receipt service used by the company that operates the store A. The check-in data represented by the two-dimensional code TC1B represents an address for accessing, via the communication network 500, the electronic receipt server that provides the electronic receipt service used by the company that operates the store B. The address may be common to all the two-dimensional codes TC1 or any one of a plurality of addresses may be represented for each of the two-dimensional codes TC1.

(10) A flag indicating which of wireless communication with the access point 6 and wireless communication with the communication network 500 the customer terminal 300 should use for data exchange with the store system 100. For example, in the store A, if wireless communication with the access point 6 is used for data exchange between the store system 100A and the customer terminal 300, the flag is set to, for example, “1”. For example, in the store B, if wireless communication with the communication network 500 is used for data exchange between the store system 100B and the customer terminal 300, the flag is set to, for example, “0”.

(11) An SSID (service set identifier) for identifying the access point 6. For example, the check-in data represented by the two-dimensional code TC1A represents an SSID for identifying the access point 6 included in the store system 100A. The check-in data represented by the two-dimensional code TC1B represents an SSID of the access point 6 included in the store system 100B.

(12) A password for accessing the access point 6. For example, the check-in data represented by the two-dimensional code TC1A represents a password set in the access point 6 included in the store system 100A. The check-in data represented by the two-dimensional code TC1B represents a password set in the access point 6 included in the store system 100B.

(13) An identification number of a security scheme used by the access point 6. As the identification number, for example, “1” is allocated to a WPA2-PSK scheme, “2” is allocated to a WPA-PSK scheme, and “3” is allocated to a WEP scheme. For example, if the access point 6 included in the store system 100A uses the WPA2-PSK scheme as the security scheme, the check-in data represented by the two-dimensional code TC1A represents “1” as the identification number. For example, if the access point 6 included in the store system 100B uses the WPA-PSK scheme as the security scheme, the check-in data represented by the two-dimensional code TC1B represents “2” as the identification number.

(14) A flag for identifying, if the customer terminal 300 fails in connection to the relay server 200, whether the failure is regarded as an error or operation is continued without regarding the failure as an error. For example, in the store A, if setting is made to regard, if the customer terminal 300 fails in connection to the relay server 200, the failure as an error, the check-in data represented by the two-dimensional code TC1A represents, for example, “1” as the flag. For example, in the store B, if setting is made to continue operation even if the terminal 300 fails in connection to the relay server 200, the check-in data represented by the two-dimensional code TC1B represents, for example, “0” as the flag.

(15) An identification number of a transmission mode concerning a status of the customer terminal 300. As the transmission mode, there are, for example, a first mode, a second mode, and a third mode. As the identification number of the transmission mode, for example, “1” is allocated to a first mode, “2” is allocated to a second mode, and “3” is allocated to a third mode. In the first mode, the status of the customer terminal 300 is transmitted to the relay server 200. In the second mode, the status of the customer terminal 300 is transmitted to the store system 100. In the third mode, the status of the customer terminal 300 is not transmitted. For example, in the store A, if the first mode is applied as the transmission mode, the check-in data represented by the two-dimensional code TC1A represents “1” as the identification number. For example, in the store B, if the second mode is applied as the transmission mode, the check-in data represented by the two-dimensional code TC1B represents “2” as the identification number.

(16) An identification number of a transmission mode concerning a log file in which log data of the customer terminal 300 is accumulated. As the transmission mode, there are, for example, a first mode, a second mode, a third mode, and a fourth mode. As the identification number of the transmission mode, for example “1” is allocated to the first mode, “2” is allocated to the second mode, “3” is allocated to the third mode, and “4” is allocated to the fourth mode. In the first mode, the log file is transmitted to only the relay server 200. In the second mode, the log file is transmitted to only the store system 100. In the third mode, the log file is transmitted to both of the store system 100 and the relay server 200. In the fourth mode, the log file is not transmitted. For example, in the store A, if the first mode is applied as the transmission mode, the check-in data represented by the two-dimensional code TC1A represents “1” as the identification number. For example, in the store B, if the second mode is applied as the transmission mode, the check-in data represented by the two-dimensional code TC1B represents “2” as the identification number.

(17) A host name or an IP address used when the log file is transmitted to the relay server 200 via the communication network 500 with an FTP (file transfer protocol).

(18) A user name used when the log file is transmitted to the relay server 200 via the communication network 500 with the FTP.

(19) A password used when the log file is transmitted to the relay server 200 via the communication network 500 with the FTP.

(20) A pass name of the log file transmitted to the relay server 200 via the communication network 500 with the FTP.

(21) A flag for identifying whether to delete a check digit of a UPC (universal product cord), which is a type of a commodity code. For example, in the store A, in operation for not deleting the check digit, the check-in data represented by the two-dimensional code TC1A represents, for example, “1” as the flag. For example, in the store B, in operation for deleting the check digit, the check-in data represented by the two-dimensional code TC1B represents, for example, “0” as the flag.

(22) A time until a camera screen is automatically transitioned in the customer terminal 300. The check-in data represented by the two-dimensional code TC1A represents, as the time, a time set in advance concerning the store A. The check-in data represented by the two-dimensional code TC1B represents, as the time, a time set in advance concerning the store B.

(23) A timeout time in communication performed by the customer terminal 300 with the store system 100 via the access point 6. The check-in data represented by the two-dimensional code TC1A represents, as the timeout time, a time set in advance concerning the store A. The check-in data represented by the two-dimensional code TC1B represents, as the timeout time, a time set in advance concerning the store B.

(24) The number of times retry is permitted if communication between the customer terminal 300 and the store system. 100 via the access point 6 times out. The check-in data represented by the two-dimensional code TC1A represents, as the number of times, the number of times set in advance concerning the store A. The check-in data represented by the two-dimensional code TC1B represents, as the number of times, the number of times set in advance concerning the store B.

(25) A timeout time in communication performed by the customer terminal 300 with the store system 100 via the relay server 200. The check-in data represented by the two-dimensional code TC1A represents, as the timeout time, a time set in advance concerning the store A. The check-in data represented by the two-dimensional code TC1B may represent, as the timeout time, a time set in advance concerning the store B.

(26) The number of times retry is permitted if communication between the customer terminal 300 and the store system 100 via the relay server 200 times out. The check-in data represented by the two-dimensional code TC1A represents, as the number of times, the number of times set in advance concerning the store A. The check-in data represented by the two-dimensional code TC1B represents, as the number of times, the number of times set in advance concerning the store B.

(27) Authentication data used in authentication processing for authenticating a declaration of a confirmation end concerning a transaction targeting commodities for which confirmation by a store clerk is necessary. The check-in data represented by the two-dimensional code TC1A represents authentication data set in advance concerning the store A. The check-in data represented by the two-dimensional code TC1B represents authentication data set in advance concerning the store B. It is preferable that the authentication data is decided to be different in each of the stores. However, the same authentication data may be set in different stores.

(28) Data for identifying an operation mode of the store system 100. For example, if the store system 100A is set in a normal mode for normally operating the transaction processing system, the check-in data represented by the two-dimensional code TC1A represents, for example, “1” as the data. For example, if the store system 100B is set in a demonstration mode for demonstratively operating the transaction processing system, the check-in data represented by the two-dimensional code TC1B represents, for example, “2” as the data.

(29) Data for identifying a mode of data transfer to the accounting machine 5. For example, if the store system 100A is set in a mode for requesting, from the accounting machine 5, the mobile controller 3 to perform data transfer, the check-in data represented by the two-dimensional code TC1A represents, for example, “1” as the data. For example, if the store system 100B is set in a mode for performing data transfer from the mobile controller 3 to the accounting machine 5 without a request from the accounting machine 5, the check-in data represented by the two-dimensional code TC1B represents, for example, “2” as the data.

(30) A flag representing whether to permit settlement in a code settlement scheme by operation in the customer terminal 300. For example, in the store A, if the code settlement is permitted, the check-in data represented by the two-dimensional code TC1A represents, for example, “1” as the flag. For example, in the store B, if the code settlement is not permitted, the check-in data represented by the two-dimensional code TC1B represents, for example, “0” as the flag.

(31) A flag for identifying whether to permit registration in the customer terminal 300 of a commodity for which an age limit for purchasers is decided (hereinafter referred to as age limited commodity). For example, in the store A, if the registration of the age limited commodity in the customer terminal 300 is permitted, the check-in data represented by the two-dimensional code TC1A represents, for example, “1” as the flag. For example, in the store B, if the code settlement is not permitted, the check-in data represented by the two-dimensional code TC1B represents for example, “0” as the flag.

(32) Data for identifying an input mode for a member code of a point member. For example, if the store system 100A is set in a mode for manually inputting the member code, the check-in data represented by the two-dimensional code TC1A represents, for example, “1” as the data. For example, if the store system 100B is set in a mode for inputting the member code by reading a barcode, the check-in data represented by the two-dimensional code TC1B represents, for example, “2” as the data.

(33) A flag for identifying whether confirmation by a store clerk is necessary in an input of the member code if the mode for manually inputting the member code of the point member is set. For example, if the confirmation is necessary in the store A, the check-in data represented by the two-dimensional code TC1A represents, for example, “1” as the flag. For example, if the confirmation is unnecessary in the store B, the check-in data represented by the two-dimensional code TC1B represents, for example, “0” as the flag.

(34) A threshold for checking battery residual power of the customer terminal 300 during check-in. The threshold is set for each of the stores or each of the companies. For example, if the company that operates the store A decides the threshold as “20%”, the check-in data represented by the two-dimensional code TC1A represents, for example, “20” as the threshold. For example, if the store B decides the threshold as “25%”, the check-in data represented by the two-dimensional code TC1B represents, for example, “25” as the threshold.

The examples of the information represented by the check-in data are as explained above. However, the check-in data may not include apart of the various kinds of information explained above. The check-in data may represent information different from the various kinds of information explained above, in at least one embodiment.

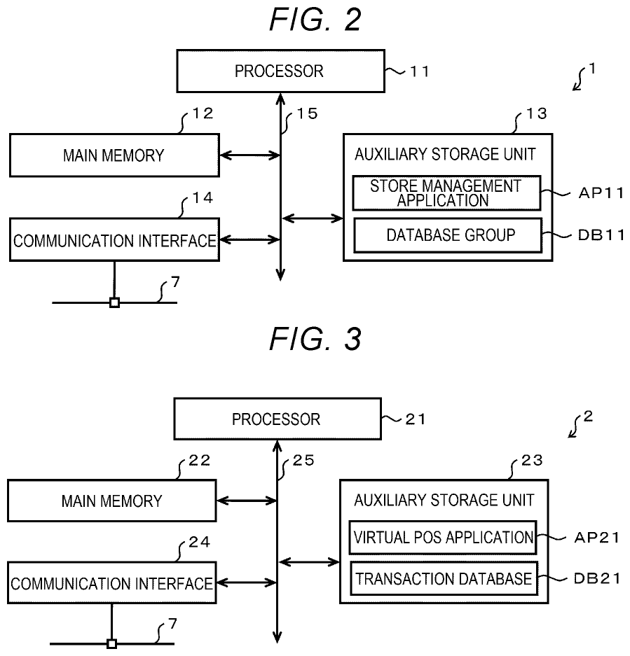

FIG. 2 is a block diagram illustrating a main part circuit configuration of the store server 1.

The store server 1 includes a processor 11, a main memory 12, an auxiliary storage unit 13, a communication interface 14, and a transmission line 15. The processor 11, the main memory 12, the auxiliary storage unit 13, and the communication interface 14 are communicably connected via the transmission line 15. The processor 11, the main memory 12, and the auxiliary storage unit 13 are connected by the transmission line 15, whereby a computer for controlling the store server 1 is configured.

The processor 11 is equivalent to a central part of the computer. The processor 11 executes, according to information processing programs such as an operating system and application programs, information processing for realizing various functions of the store server 1. The processor 11 may be, for example, a CPU (central processing unit).

The main memory 12 is equivalent to a main storage part of the computer. The main memory 12 includes a nonvolatile memory region and a volatile memory region. The main memory 12 stores the information processing programs in the nonvolatile memory region. The main memory 12 sometimes stores, in the nonvolatile or volatile memory region, data necessary for the processor 11 in executing the information processing. The main memory 12 uses the volatile memory region as a work area where data is rewritten as appropriate by the processor 11. The nonvolatile memory region may be, for example, a ROM (read only memory). The volatile memory region may be, for example, a RAM (random access memory).

The auxiliary storage unit 13 is equivalent to an auxiliary storage part of the computer. As the auxiliary storage unit 13, for example, a storage unit including a well-known storage device such as an EEPROM (electric erasable programmable read-only memory), a HDD (hard disc drive), or an SSD (solid state drive) can be used. The auxiliary storage unit 13 saves data used by the processor 11 in performing various kinds of processing, data created by the processing in the processor 11, or the like. The auxiliary storage unit 13 sometimes stores the information processing programs.

The communication interface 14 performs data communication between the communication interface 14 and the units connected to the intra-store communication network 7 according to a predetermined communication protocol. As the communication interface 14, for example, a well-known communication device for LAN can be applied.

The transmission line 15 includes an address bus, a data bus, and a control signal line and transmits data and control signals exchanged among the connected units.

The auxiliary storage unit 13 stores a store management application AP11, which is one of the information processing programs. The store management application AP11 is an application program and is described about information processing for realizing the functions of the store server 1. The store management application AP11 may be a separate application created to be adapted to a store operation policy of each of the stores or each of the companies that operate the stores. For example, if management methods for sales data are different between the store A and the store B, the store management application AP11 used in the store system 100A is described about information processing for management of sales data adapted to the management method for sales data in the store A and the store management application AP11 used in the store system 100B is described regarding information processing for management of sales data adapted to the management method for the sales data in the store B.

Apart of a storage region of the auxiliary storage unit 13 is used as a database group DB11. The database group DB11 includes a plurality of databases for various kinds of information management. One of the databases included in the database group DB11 is a commodity database for managing commodities sold in the store. The commodity database is a set of data records correlated with management target commodities. The data records of the commodity database include data concerning correlated commodities such as a commodity code, a price, and a commodity name. The commodity code is an identification code decided to identify the commodities for each of SKUs (stock keeping units). For example, a JAN (Japanese article number) code is used. The commodity name is a name decided to allow a human to easily distinguish a commodity. The price is an amount paid for sales of a commodity.

One of the databases included in the database group DB11 is a user database for managing users of the store. The user database is a set of data records correlated with customers registered as users. The data records of the user database include data concerning the correlated customers such as user codes and attribute information for specifying the users. The user codes are unique identification codes decided for each of the customers in order to individually identify the users. The attribute information could include a name, sex, age, an address, and a telephone number. The data records of the user database sometimes include settlement information declared by the users. The settlement information is a credit number, a code settlement ID (identifier), and the like. If a plurality of settlement methods are selectable, the settlement information sometimes includes settlement method codes for identifying the settlement methods. In the case of a store that provides a point service, the settlement information sometimes includes an ID of the point service and the number of owned points.

Besides, the database group DB 11 could include various databases managed by a POS server in the existing POS system. It may be decided for each of the stores what kinds of databases the database group DB 11 includes or what kinds of data in what kinds of structure the databases include.

FIG. 3 is a block diagram illustrating a main part circuit configuration of the virtual POS server 2.

The virtual POS server 2 includes a processor 21, a main memory 22, an auxiliary storage unit 23, a communication interface 24, and a transmission line 25. The processor 21, the main memory 22, the auxiliary storage unit 23, and the communication interface 24 are communicably connected via the transmission line 25. The processor 21, the main memory 22, and the auxiliary storage unit 23 are connected by the transmission line 25, whereby a computer for controlling the virtual POS server 2 is configured. Overviews of functions of the processor 21, the main memory 22, the auxiliary storage unit 23, the communication interface 24, and the transmission line 25 are equivalent to the overviews of the functions of the processor 11, the main memory 12, the auxiliary storage unit 13, the communication interface 14, and the transmission line 15. Therefore, explanation of the overviews of the functions is omitted.

The auxiliary storage unit 23 stores a virtual POS application AP21. The virtual POS application AP21 is an application program and is described about information processing for realizing functions of the virtual POS server 2. The virtual POS application AP21 may be a separate application created to be adapted to a store operation policy of each of the stores or each of the companies that operate the stores. For example, in the store A, if a discount service not performed in the store B is performed, the virtual POS application AP21 used in the store system 100A is described regarding information processing for realizing the discount service. The virtual POS application AP21 used in the store system 100B is not described about the information processing for realizing the discount service.

A part of the storage region of the auxiliary storage unit 23 is used as a transaction database DB21. The transaction database DB21 is a set of data records correlated with a transaction with a customer shopping in the store. The data records of the transaction database DB21 include transaction codes and commodity data concerning commodities registered as purchased commodities. The transaction codes are unique identification codes set for each of the transactions in order to identify the individual transactions. The commodity data represents a commodity code, a commodity name, a prices, the number of items, and the like. The structure of the transaction database DB21 may be individually decided to be adapted to a store operation policy of each of the stores or each of the companies that operate the stores.

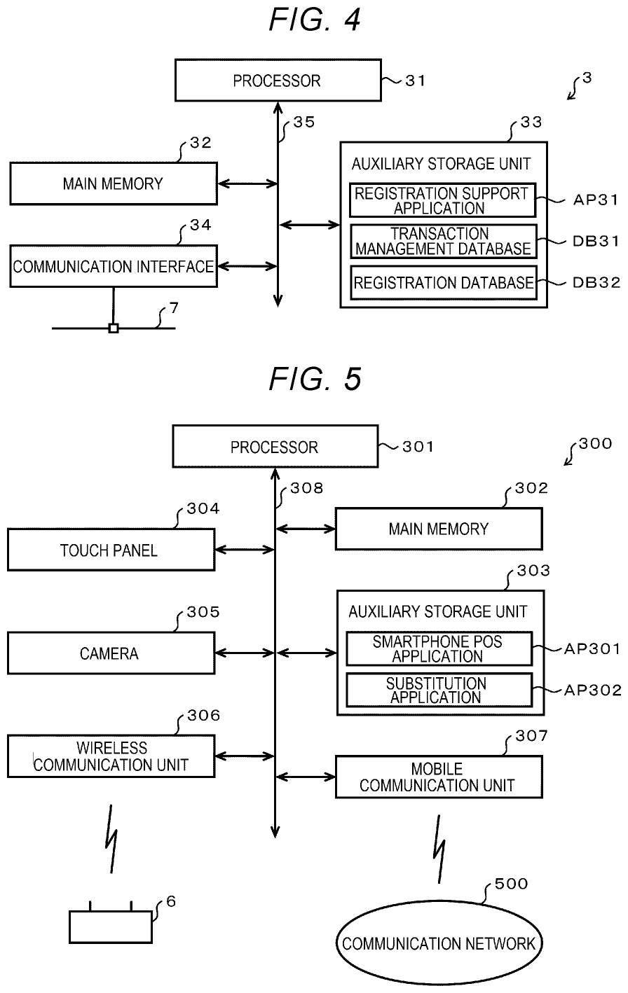

FIG. 4 is a block diagram illustrating a main part circuit configuration of the mobile controller 3.

The mobile controller 3 includes a processor 31, a main memory 32, an auxiliary storage unit 33, a communication interface 34, and a transmission line 35. The processor 31, the main memory 32, the auxiliary storage unit 33, and the communication interface 34 are communicably connected via the transmission line 35. The processor 31, the main memory 32, and the auxiliary storage unit 33 are connected by the transmission line 35, whereby a computer for controlling the mobile controller 3 is configured. Overviews of functions of the processor 31, the main memory 32, the auxiliary storage unit 33, the communication interface 34, and the transmission line 35 are equivalent to the overviews of the functions of the processor 11, the main memory 12, the auxiliary storage unit 13, the communication interface 14, and the transmission line 15. Therefore, explanation of the overviews of the functions is omitted.

However, the auxiliary storage unit 33 stores a registration support application AP31. The registration support application AP31 is an application program and is described about information processing for supporting registration of purchased commodities. The registration support application AP31 is common to the store systems 100. However, various settings for the information processing based on the registration support application AP31 may be customized for each of the store systems 100.

A part of a storage region of the auxiliary storage unit 23 is used as a transaction management database DB31 and a registration database DB32. The structures of the transaction management database DB31 and the registration database DB32 are common to the store systems 100.

The transaction management database DB31 is a set of data records correlated with the customer terminals 300 used by customers in the store. Accordingly, if one customer is present in the store, the transaction management database DB31 includes one data record. If no customer is present in the store, the transaction management database DB31 does not include data record. The data record of the transaction management database DB31 correlates, with terminal IDs (identifiers) of the customer terminals 300, members codes for identifying customers using the customer terminals 300 and transaction codes for identifying transactions performed using the customer terminals 300 and describes the member codes and the transaction codes.

The registration database DB32 is a set of data records correlated with a transaction of a customer shopping in the store. In the data records of the registration database DB32, for example, registration data concerning each of commodities registered as purchased commodities is correlated with transaction codes and described. The registration data includes, for example, a commodity code, a price, the number of items, and a cancellation flag. The cancellation flag is set when a commodity concerning the registration data including the cancellation flag is cancelled from the registered commodities.

FIG. 5 is a block diagram illustrating a main part configuration of the customer terminal 300.

The customer terminal 300 may include a processor 301, a main memory 302, an auxiliary storage unit 303, a touch panel 304, a camera 305, a wireless communication unit 306, a mobile communication unit 307, and a transmission line 308. The processor 301, the main memory 302, the auxiliary storage unit 303, the touch panel 304, the camera 305, and the mobile communication unit 307 are communicably connected via the transmission line 308. The processor 301, the main memory 302, and the auxiliary storage unit 303 are connected by the transmission line 308, whereby a computer for controlling the customer terminal 300 is configured. Overviews of functions of the processor 301, the main memory 302, the auxiliary storage unit 303, and the transmission line 308 are equivalent to the overviews of the functions of the processor 11, the main memory 12, the auxiliary storage unit 13, and the transmission line 15. Therefore, explanation of the overviews of the functions is omitted.

The touch panel 304 functions as an operation device and a display device of the customer terminal 300.

The camera 305 includes an optical system and an image sensor and generates, with the image sensor, image data representing an image in a visual field formed by the optical system.

The wireless communication unit 306 exchanges data between the wireless communication unit 306 and the access point 6 through wireless communication conforming to a wireless communication protocol. As the wireless communication unit 306, for example, a well-known communication device conforming to the IEEE802.11 standard can be used.

The mobile communication unit 307 is an interface of data communication via the communication network 500. As the mobile communication unit 307, for example, a well-known communication device for performing data communication via a mobile communication network can be used.

The auxiliary storage unit 303 stores a smartphone POS application AP301 and a substitution application AP302, each of which is one of the information processing programs. The smartphone POS application AP301 is an application program and is described about information processing for causing the customer terminal 300 to function as a user interface of the store system 100. The substitution application AP302 is described about information processing explained below for receiving substitution operation by the store clerk terminal 400. The smartphone POS application AP301 and the substitution application AP302 are used in common in a plurality of customer terminals 300. The smartphone POS application AP301 and the substitution application AP302 may be replaced with one application program including two program modules corresponding to the smartphone POS application AP301 and the substitution application AP302.

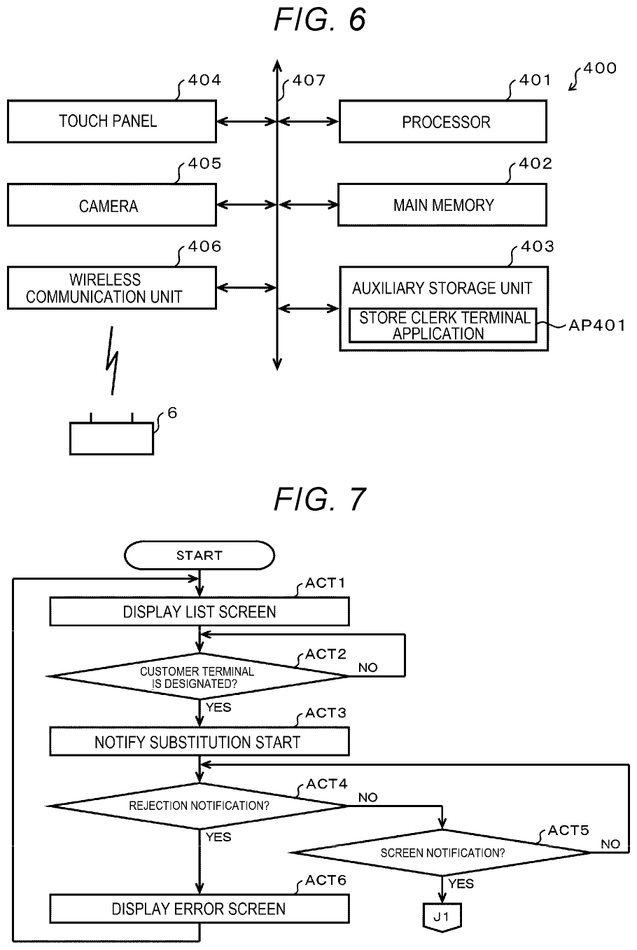

FIG. 6 is a block diagram illustrating a main part circuit configuration of the store clerk terminal 400.

The store clerk terminal 400 may include a processor 401, a main memory 402, an auxiliary storage unit 403, a touch panel 404, a camera 405, a wireless communication unit 406, and a transmission line 407. The processor 401, the main memory 402, the auxiliary storage unit 403, the touch panel 404, the camera 405, and the wireless communication unit 406 are communicably connected via the transmission line 407. The processor 401, the main memory 402, and the auxiliary storage unit 403 are connected by the transmission line 407, whereby a computer for controlling the store clerk terminal 400 is configured. Overviews of functions of the processor 401, the main memory 402, the auxiliary storage unit 403, the touch panel 404, the camera 405, and the wireless communication unit 406 and the transmission line 407 are equal to the overviews of the functions of the processor 11, the main memory 12, the auxiliary storage unit 13, the touch panel 304, the camera 305, and the wireless communication unit 306 and the transmission line 15. Therefore, explanation of the overviews of the functions is omitted. The store clerk terminal 400 may include a unit having the same function as the function of the mobile communication unit 307.

The auxiliary storage unit 403 stores a store clerk terminal application AP401, which is one of the information processing programs. The store clerk terminal application AP401 is an application program and is described about information processing explained below for causing the store clerk terminal 400 to function as a user interface of the store system 100.

As hardware of the store server 1, the virtual POS server 2, or the mobile controller 3, for example, a general-purpose server apparatus can be used. In general, transfer of the store server 1, the virtual POS server 2, or the mobile controller is performed in a state in which the store management application AP11, the virtual POS application AP21, or the registration support application AP31 is stored in the auxiliary storage unit 13, 23, or 33 and the database group DB11, the transaction database DB21, or the transaction management database DB31 and the registration database DB32 need not be stored in the auxiliary storage units 13, 23, or 33. However, the hardware in a state in which the store management application AP11, the virtual POS application AP21, or the registration support application AP31 are not stored in the auxiliary storage unit 13, 23, or 33 or a state in which an application program of the same type and another version is stored in the auxiliary storage unit 13, 23, or 33 and the store management application AP11, the virtual POS application AP21, or the registration support application AP31 may be individually transferred. The store management application AP11, the virtual POS application AP21, or the registration support application AP31 is written in the auxiliary storage unit 13, 23, or 33 according to operation by any operator, whereby the store server 1, the virtual POS server 2, or the mobile controller 3 may be configured. Transfer of the store management application AP11, the virtual POS application AP21, or the registration support application AP31 can be performed by recording the store management application AP11, the virtual POS application AP21, or the registration support application AP31 in a removable recording medium such as a magnetic disk, a magneto-optical disk, an optical disk, or a semiconductor memory or can be performed by communication via a network. The processor 11, 21, or 31 executes the information processing based on the store management application AP11, the virtual POS application AP21, or the registration support application AP31, whereby the transaction database DB21 or the transaction management DB31 and the registration database DB32 are configured in the auxiliary storage unit 13, 23, or 33. The store management application AP11 and at least a part of the databases included in the database group DB11 may be stored in the main memory 12. The virtual POS application AP21 and at least a part of the transaction database DB21 may be stored in the main memory 22. The registration support application AP31 and at least a part of the transaction management database DB31 and the registration database DB32 may be stored in the main memory 32.

As the store clerk terminal 400, a portable general-purpose information processing apparatus such as a smartphone or a tablet computer, which are handheld devices, or a stationary general-purpose information processing apparatus such as a desktop computer can be used. In general, transfer of the store clerk terminal 400 is performed in a state in which hardware in a state in which the store clerk terminal application AP401 is not stored in the auxiliary storage unit 403 and the store clerk terminal application AP401 are separate. The store clerk terminal application AP401 is written in the auxiliary storage unit 403 according to operation by any operator, whereby the store clerk terminal 400 may be configured. Transfer of the store clerk terminal application AP401 can be performed by recording the store clerk terminal application AP401 in a removable recording medium such as a magnetic disk, a magneto-optical disk, an optical disk, or a semiconductor memory or can be performed by communication via a network. However, the store clerk terminal 400 in a state in which the store clerk terminal application AP401 is written in the auxiliary storage unit 403 may be transferred. The store clerk terminal application AP401 may be stored in the main memory 402.

The operation of the transaction processing system configured as explained above is explained. Contents of various kinds of processing explained below are examples. A change of the order of a part of the processing, omission of a part of the processing, addition of another kind of processing, or the like can be performed as appropriate. For example, in the following explanation, explanation about a part of the processing is omitted in order to clearly explain characteristic operations in at least one embodiment. For example, if some error occurs, processing for coping with the error is sometimes performed. However, description is omitted about a part of such processing.

A service provided to customers by the operation of the transaction processing system explained below is referred to as smartphone POS service.

In order to use the smartphone POS service, a customer installs the smartphone POS application AP301 and the substitution application AP302 in a general-purpose information terminal such as a smartphone or a tablet computer carried by the customer and enables the information terminal to be used as the customer terminal 300. Alternatively, the customer borrows, in the store, the customer terminal 300 configured by installing the smartphone POS application AP301 in a tablet terminal or the like. The customer may carry the customer terminal 300 in a state in which the information processing based on the smartphone POS application AP301 is started and enters any store in which the store system 100 is provided.

If entering the store and starting shopping, the customer performs predetermined operation for designating the shopping start in the customer terminal 300. The customer causes the camera 305 to photograph the two-dimensional code TC1 posted near the entrance of the store. Consequently, the customer terminal 300 acquires the check-in data explained above and thereafter performs operation adapted to setting of the store system 100 indicated by the check-in data. The customer terminal 300 requests, based on the check-in data, the mobile controller 3 to perform check-in. In response to the request, in the mobile controller 3, the processor 31 starts support processing for supporting the virtual POS server 2 in processing a transaction with the customer who is using the customer terminal 300. The virtual POS server 2 performs registration processing and accounting processing under the support by the mobile controller 3 according to an instruction of the customer by operation of the customer terminal 300.

In the customer terminal 300, the processor 301 inputs an instruction by the customer for the registration processing and the accounting processing. Specifically, in order to receive various instructions of the customer for the registration processing and the accounting processing, the processor 301 causes the touch panel 304 of the customer terminal 300 to display various operation screens and then waits for an instruction by the customer. The processor 301 receives an instruction for commodity registration, a change of the number of items of a purchased commodity, cancellation of the purchased commodity, a start of accounting, in which of operation in the customer terminal 300 and the accounting machine 5 the accounting is performed, a settlement method, or settlement information applied to settlement such as a credit number. The processor 301 executes information processing based on the smart phone POS application AP301 in this way, whereby a computer including the processor 301 as a central part functions as a first input unit (a first receiver). The customer terminal 300 is an example of a first apparatus.

The instruction is input in the customer terminal 300. However, the customer terminal 300 may directly notify content of the instruction to the mobile controller 3. In the mobile controller 3, the processor 31 may determine which of the various instruction is performed.

The registration processing is processing for registering, as a purchased commodity, a commodity that the customer is about to purchase. The accounting processing is processing for calculating a price of the purchased commodity and causing the customer to settle the price. The registration processing and the accounting processing may be the same processing as, for example, processing performed by a POS server in the existing POS system according to operation in the POS terminal. The registration processing and the accounting processing are realized by information processing by the processor 21. The registration processing and the accounting processing are equivalent to information processing for processing a transaction. The processor 21 executes the information processing based on the virtual POS application AP21 in this way, whereby a computer including the processor 21 as a central part functions as a processing unit.

The support processing by the mobile controller 3 is processing for giving an instruction input in the customer terminal 300 to the virtual POS server 2 as if the instruction is an instruction given by the POS terminal, and causing the customer terminal 300 to operate like the POS terminal. The support processing is realized by information processing by the processor 31.

In at least one embodiment, in principle, the instruction for the registration processing and the accounting processing should be performed by the customer. However, in the case of a customer unaccustomed to use of the smartphone POS service or operation of the customer terminal 300, the customer sometimes cannot appropriately give the instruction. It is conceivable that such a customer inquires a store clerk about the operation of the customer terminal 300. The store clerk receiving such an inquiry supports the customer using the store clerk terminal 400 that starts the information processing by the store clerk terminal application AP401.

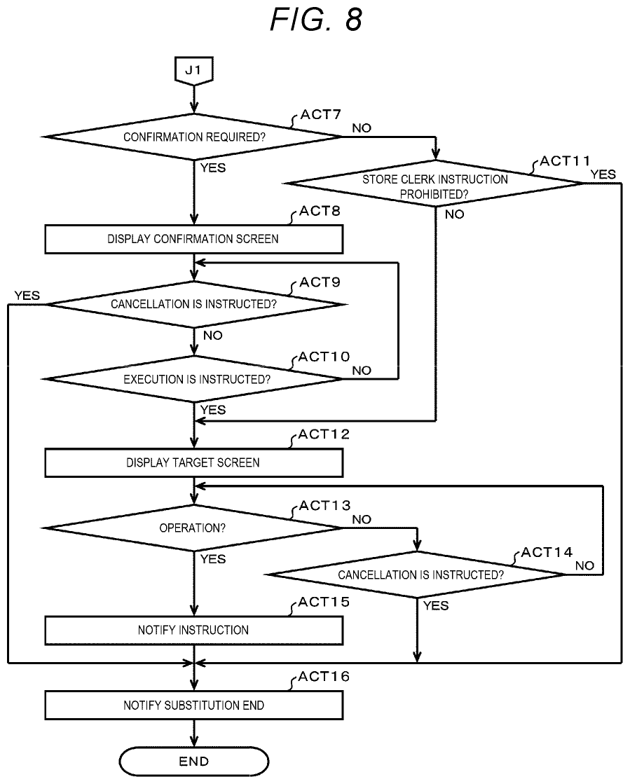

FIGS. 7 and 8 are flowcharts of the information processing based on the store clerk terminal application AP401 by the processor 401.

In ACT 1 in FIG. 7, the processor 401 causes the touch panel 404 to display a list screen. The list screen is a screen for displaying a list of the customer terminals 300 in operation in the store and causing a store clerk to designate one customer terminal 300 set as a target of operation substitution out of those customer terminals 300. For example, the processor 401 acquires a list of the customer terminals 300 in operation in the store from the mobile controller 3, generates a list screen showing the list, and causes the touch panel 404 to display the list screen. The generation of the list screen may be performed by the processor 31 in the mobile controller 3.

In ACT 2, the processor 401 waits for the customer terminal 300 set as a target of the operation substitution to be designated. The store clerk confirms the list screen and designates the customer terminal 300 used by the inquiring customer. According to the designation, the processor 401 determines YES and proceeds to ACT 3.

In ACT 3, the processor 401 notifies a substitution start to the customer terminal 300. For example, the processor 401 transmits notification data for notifying the substitution start to the mobile controller 3 from the wireless communication unit 406. The processor 401 includes, in the notification data, as identification data representing a reason for the notification, identification data predetermined as representing the notification of the substitution start. The processor 401 includes, in the notification data, a terminal ID of the customer terminal 300 as a notification destination ID. The processor 401 includes, in the notification data, as a notification source ID, a terminal ID of the store clerk terminal 400 in which the processor 401 is provided. The notification data is transmitted to the mobile controller 3 by the access point 6 and the intra-store communication network 7. The notification data is received by the communication interface 34 in the mobile controller 3.

According to the reception of the notification data, in the mobile controller 3, the processor 31 transmits notification data for notifying the substitution start from the communication interface 34 to the customer terminal 300 identified by the notification destination ID included in the received notification data. The processor 301 may directly transfer the notification data received by the communication interface or may transmit other notification data based on the notification data. The processor 301 includes, in the notification data to be transmitted, as identification data representing a reason for the notification, identification data predetermined as representing the notification of the substitution start and includes, in the notification data to be transmitted, the notification source ID included in the received notification data. The identification data included in the notification data transmitted from the store clerk terminal 400 and the identification data included in the notification data transmitted to the customer terminal 300 may represent the same reason or may be different from each other. The notification data is transmitted to the customer terminal 300 via the intra-store communication network 7 and the access point 6 or via the intra-store communication network 7, the communication server 4, the communication network 500, the relay server 200, and the communication network 500. The notification data is received by the wireless communication unit 306 or the mobile communication unit 307 in the customer terminal 300.

Various notifications from the store clerk terminal 400 to the customer terminal 300 in the following explanation are performed in the same manner as explained above via the mobile controller 3. Various notifications from the customer terminal 300 to the store clerk terminal 400 in the following explanation is performed in a flow opposite to the flow explained above via the mobile controller 3.

The customer terminal 300 and the store clerk terminal 400 may perform various notifications via the intra-store communication network 7 and not via the mobile controller 3. The customer terminal 300 and the store clerk terminal 400 may perform notifications to each other through direct wireless communication between the customer terminal 300 and the store clerk terminal 400.

In the customer terminal 300, if the substitution start is notified, the processor 301 starts information processing based on the substitution application AP302. At this time, the processor 301 executes the information processing based on the substitution application AP302 in parallel without ending the information processing based on the smartphone POS application AP301 executed as explained above.

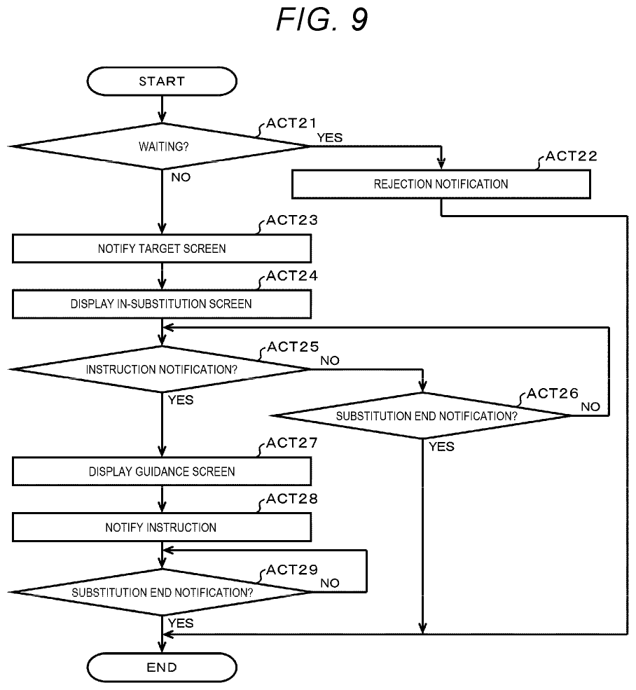

FIG. 9 is a flowchart of the information processing based on the substitution application AP302 by the processor 301.

In ACT 21, the processor 301 confirms whether the information processing based on the smartphone POS application AP301 is in a state of waiting for an instruction by the customer. If the information processing is not in the waiting state, the processor 301 determines NO and proceeds to ACT 22.

In ACT 22, the processor 301 notifies the store clerk terminal 400 at a notification source of the substitution start that the substitution start is rejected. Accordingly, the processor 301 ends the information processing based on the substitution application AP302.

If the information processing is in the state of waiting for an instruction by the customer, the processor 301 determines YES in ACT 21 and proceeds to ACT 23.

In ACT 23, the processor 301 notifies the store clerk terminal 400 at the notification source of the substitution start which screen is a screen set as a target of the substitution operation (hereinafter referred to as target screen). Since operation on a screen displayed in the customer terminal 300 is unknown for the customer, the screen being displayed is the target screen. For example, the processor 301 may include, in notification data for the notification, a screen ID of a screen displayed on the touch panel 304 in order to wait for an instruction from the customer in the information processing based on the smartphone POS application AP301.

In the store clerk terminal 400, after notifying the substitution start in ACT 3 in FIG. 7, the processor 401 proceeds to ACT 4.

In ACT 4, the processor 401 confirms whether a rejection notification is performed. If failing in confirming the notification, the processor 401 determines NO and proceeds to ACT 5.

In ACT 5, the processor 401 confirms whether a screen notification is performed. If failing in confirming the notification, the processor 401 determines NO and returns to ACT 4.

In this way, in ACT 4 and ACT 5, the processor 401 waits for the rejection notification or the screen notification. If the rejection notification is received from the customer terminal 300 as explained above, the processor 401 determines YES in ACT 4 and proceeds to ACT 6.

In ACT 6, the processor 401 causes the touch panel 404 to display an error screen. The error screen is a screen predetermined as informing the store clerk that the customer terminal 300 is not in a situation in which operation is performed substituting for the customer. If a predetermined end condition is satisfied, the processor 401 returns to ACT 1 and returns the display on the touch panel 404 to the list screen.

On the other hand, if the screen notification is received from the customer terminal 300 as explained above, the processor 401 determines YES in ACT 5 and proceeds to ACT 7 in FIG. 8.

In ACT 7, the processor 401 confirms whether the target screen is a screen preset as confirmation required. A screen, for which substitution operation by the store clerk is permitted but which is preferably operated by the customer, is preset as confirmation required. However, which screen is specifically set as confirmation required may be optionally decided by an administrator or the like of the store. If the target screen is set as confirmation required, the processor 401 determines YES and proceeds to ACT 8.

In ACT 8, the processor 401 causes the touch panel 404 to display a confirmation screen. The confirmation screen is a screen for causing the store clerk to select whether a substitution operation concerning the target screen is performed.

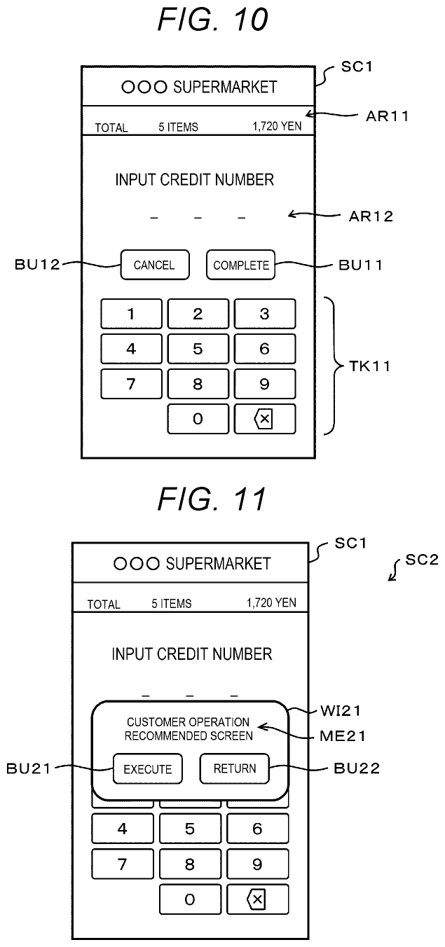

FIG. 10 is a diagram illustrating an example of an input screen SC1.

The input screen SC1 is a screen that, in the customer terminal 300, the processor 301 causes the touch panel 304 to display in order to cause the customer to input a credit number in the information processing based on the smartphone POS application AP301. The input screen SC1 includes a display area AR11, an input area AR12, buttons BU11 and BU12, and a tenkey TK11. The display area AR11 represents a total number and a total amount of registered commodities. In the example illustrated in FIG. 10, five commodities are registered in total and a total amount of the commodities is 1,720 yen. An input area AR12 is an area for inputting a credit number. In the example illustrated in FIG. 10, a state in which the credit number is not input yet is illustrated. The button BU11 is a softkey for the customer to instruct input completion of the credit number. The button BU12 is a softkey for the customer to cancel the input of the credit number. The tenkey TK11 is a softkey group for the customer to input numbers.

It is preferable that operation for the input of the credit number is performed by the customer. However, if the input of the credit number by the store clerk is permitted according to a desire of the customer, it is assumed that the input screen SC1 is set as confirmation required.

FIG. 11 is a diagram illustrating an example of a confirmation screen SC2.

In the confirmation screen SC2 in the example illustrated in FIG. 11, the customer terminal 300 in a state in which the input screen SC1 illustrated in FIG. 10 is displayed on the touch panel 304 is designated as a target of the operation substitution.

The confirmation screen SC2 is a screen on which a window WI21 is displayed over the input screen SC1. The window WI21 represents a message ME21 and buttons BU21 and BU22. The message ME21 is a character message for informing the store clerk that it is recommended that an instruction on a screen set as a target of the operation substitution is performed by the customer. The button BU21 is a softkey for the store clerk to instruct execution of the operation substitution. The button BU21 is a softkey for the store clerk to instruct cancellation of the operation substitution.

If the target screen set as confirmation required is displayed in the store clerk terminal 400, a state in which the processor 401 functioning as a second input unit (a second receiver) inputs an instruction predetermined as being recommended to be performed by the customer is formed. The confirmation screen is a screen for informing the store clerk that an instruction should be input by the processor 301 functioning as the first input unit. The processor 401 executes the information processing based on the store clerk terminal application AP401 in this way, whereby a computer including the processor 401 as a central part functions as a first informing unit.

The display of the confirmation screen SC2 can call the store clerk's attention to the fact that it is preferable that an input of an instruction on the target screen is performed by the customer. The store clerk determines, while considering that it is preferable that the instruction is performed by the customer, whether to execute the operation substitution or cancel the operation substitution and cause the customer to perform operation. If the store clerk executes the operation substitution, the store clerk instructs the execution with predetermined operation for, for example, touching the button BU21. If the store clerk cancels the operation substitution, the store clerk instructs the cancellation with predetermined operation for, for example, touching the button BU22.

The processor 401 proceeds to ACT 9 in FIG. 8 in a state in which the processor 401 causes the touch panel 404 to display the confirmation screen SC2.

In ACT 9, the processor 401 confirms whether the cancellation of the operation substitution is instructed. If failing in confirming the instruction, the processor 401 determines NO and proceeds to ACT 10.

In ACT 10, the processor 401 confirms whether the execution of the operation substitution is instructed. If failing in confirming the instruction, the processor 401 determines NO and returns to ACT 9.

In this way, in ACT 9 and ACT 10, the processor 401 waits for the cancellation or the execution of the operation substitution to be instructed. If confirming that the execution is instructed by the store clerk as explained above, the processor 401 determines YES in ACT 10 and proceeds to ACT 12.

On the other hand, if the target screen is not set as confirmation required, the processor 401 determines NO in ACT 7 and proceeds to ACT 11.

In ACT 11, the processor 401 confirms whether the target screen is set to store clerk instruction prohibited. A screen that is not to be operated in a substituted manner by the store clerk is set in advance as store clerk instruction prohibited. However, which screen is specifically set as store clerk instruction prohibited may be optionally decided by the administrator or the like of the store. For example, in a store in which it is prohibited to ask a customer about a credit number, the input screen SC1 is set as store clerk instruction prohibited. If the target screen is not set as store clerk instruction prohibited, the processor 401 determines NO and proceeds to ACT 12.

In this way, if the target screen is set neither as confirmation required nor as the store clerk instruction prohibited and if the target screen is set as confirmation required but the execution of the substitution operation is instructed on the configuration screen, the processor 401 proceeds to ACT 12.

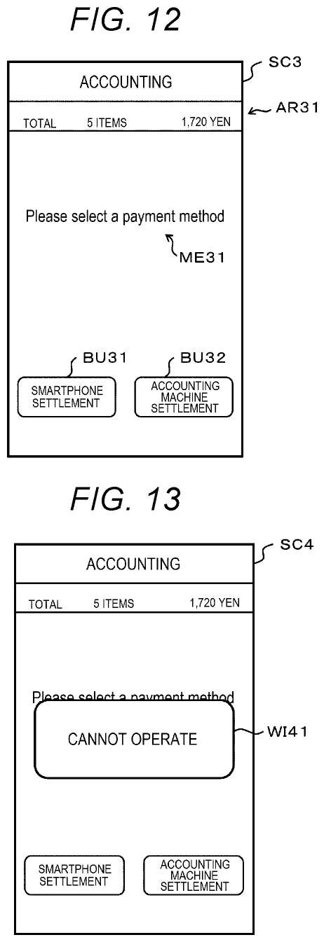

FIG. 12 is a diagram illustrating an example of a selection screen SC3.

The selection screen SC3 is a screen that, in the customer terminal 300, the processor 301 causes the touch panel 304 to display in order to cause the customer to select a payment method for a price in the information processing based on the smartphone POS application AP301.

The selection screen SC3 includes a display area AR31, a message ME31, and buttons BU31 and BU32. The display area AR31 represents a total number and a total amount of registered commodities. In the example illustrated in FIG. 12, five commodities are registered in total and a total amount of the commodities is 1,720 yen. The message ME31 is a character message for urging the user to select a payment method. The button BU31 is a softkey for the customer to instruct to perform settlement with operation in the customer terminal 300. The button BU32 is a softkey for the customer to instruct to perform settlement using the accounting machine 5.

In general, the store clerk may perform, substituting for the customer, an instruction of a settlement method on the selection screen SC3. Therefore, it is assumed that neither the setting of confirmation required nor the setting of the store clerk instruction prohibited is performed on the selection screen SC3. Accordingly, if the selection screen SC3 is the target screen, the processor 401 determines NO in both of ACT 7 and ACT 11 in FIG. 8 and proceeds to ACT 12.

In ACT 12, the processor 401 causes the touch panel 404 to display the target screen. Data of all screens that could be the target screen among screens displayed in the customer terminal 300 may be stored in advance in the auxiliary storage unit 403 of the store clerk terminal 400. Alternatively, all the screens that could be the target screen among the screens displayed in the customer terminal 300 are set to be able to be generated by the information processing by the processor 401. Screen data of the target screen may be transmitted from the customer terminal 300 to the store clerk terminal 400.

The store clerk performs, substituting for the customer, operation that the customer should perform concerning the target screen displayed on the touch panel 404 of the store clerk terminal 400. If the store clerk cancels the operation substitution for some reason, the store clerk instructs the cancellation with predetermined operation for, for example, touching a button for cancellation instruction additionally displayed on the target screen.

In ACT 13, the processor 401 confirms whether operation concerning the target screen is performed. If the operation is not performed, the processor 401 determines NO and proceeds to ACT 14.

In ACT 14, the processor 401 confirms whether cancellation of the substitution is instructed. If failing in confirming the instruction, the processor 401 determines NO and returns to ACT 13.

In this way, in ACT 13 and ACT 14, the processor 401 waits for the operation concerning the target screen or the instruction for the cancellation. If the operation concerning the target screen is performed as explained above, the processor 401 determines YES in ACT 13 and proceeds to ACT 15.

In ACT 15, the processor 401 notifies the instruction performed by the operation to the customer terminal 300. Thereafter, the processor 401 proceeds to ACT 16. At this time, the processor 401 inputs an instruction by the store clerk. The processor 401 executes the information processing based on the store clerk terminal application AP401 in this way, whereby the computer including the processor 401 as the central part functions as a second input unit. The store clerk terminal 400 is an example of a second apparatus.

If confirming that the cancellation is instructed when the confirmation screen SC2 is displayed, the processor 401 determines YES in ACT 9 and proceeds to ACT 16 passing ACT 10 to ACT 15. If the target screen is set to store clerk instruction prohibited, the processor 401 determines YES in ACT 11 and proceeds to ACT 16 passing ACT 12 to ACT 15. If confirming that the cancellation is instructed as explained above when the target screen is displayed, the processor 401 determines YES in ACT 14 and proceeds to ACT 16 passing ACT 15. That is, in these cases, the processor 401 proceeds to ACT 16 without executing ACT 15.

In ACT 16, the processor 401 notifies a substitution end to the customer terminal 300. Thereafter, the processor 401 ends the information processing based on the store clerk terminal application AP401.

In the customer terminal 300, if notifying the target screen in ACT 23 in FIG. 9, the processor 301 proceeds to ACT 24.

In ACT 24, the processor 301 causes the touch panel 304 to display an in-substitution screen. The in-substitution screen is a screen for informing the customer a state in which operation is performed by the store clerk terminal 400 substituting for the customer.

FIG. 13 is a diagram illustrating an example of an in-substitution screen SC4.

The in-substitution screen SC4 in the example illustrated in FIG. 13, the customer terminal 300 in a state in which the selection screen SC3 illustrated in FIG. 12 is displayed on the touch panel 304 is designated as a target of the operation substitution.

The in-substitution screen SC4 illustrated in FIG. 13 is formed by superimposing a window WI41 on an image representing appearance of the selection screen SC3. The in-substitution screen SC4 represents appearance of the buttons BU31 and BU32 on the selection screen SC3 but does not have functions of softkeys. The window WI41 represents a character message for informing the customer that the customer cannot perform operation because the operation is performed by the store clerk terminal 400 substituting for the customer. That is, the display of the in-substitution screen SC4 is equivalent to informing the customer that an input of an instruction by the processor 301 functioning as the first input unit is invalid. The processor 301 executes the information processing based on the substitution application AP302 in this way, whereby the computer including the processor 301 as the central part functions as a second informing unit.

Although the customer requests the store clerk to perform operation substituting for the customer, if an instruction can be input in the customer terminal 300 as well, it is likely that some instruction is input in the customer terminal 300 as well. However, if the in-substitution screen SC4 is displayed, an instruction by the customer cannot be received in the information processing based on the smartphone POS application AP301. Consequently, an instruction based on the same screen is prevented from being performed in both of the customer terminal 300 and the store clerk terminal 400.

The processor 301 proceeds to ACT 25 in FIG. 9 in a state in which the processor 301 causes the touch panel 304 to display the in-substitution screen SC4.

In ACT 25, the processor 301 confirms whether an instruction is notified. If failing in confirming the notification, the processor 401 determines NO and proceeds to ACT 26.

In ACT 26, the processor 301 confirms whether an end of the operation substitution is notified. If failing in confirming the notification, the processor 301 determines NO and returns to ACT 25.

In this way, in ACT 25 and ACT 26, the processor 301 waits for the instruction or the end of the operation substitution to be notified. In the information processing based on the smartphone POS application AP301, the processor 301 does not regard the operation on the target screen displayed on the in-substitution screen SC4 as an instruction on the target screen.

If confirming that the instruction is notified from the store clerk terminal 400 as explained above, the processor 301 determines YES in ACT 25 and proceeds to ACT 27.

In ACT 27, the processor 301 causes the touch panel 304 to display a guidance screen. The guidance screen is a screen for informing the substitute operation in the store clerk terminal 400 to the customer.

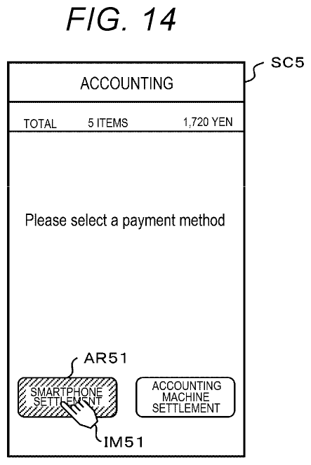

FIG. 14 is a diagram illustrating an example of a guidance screen SC5.

In the guidance screen SC5 in the example illustrated in FIG. 14, the selection screen SC3 illustrated in FIG. 12 is set as the target screen and settlement by operation in the customer terminal 300 is instructed by the store clerk in the store clerk terminal 400.

On the guidance screen SC5 illustrated in FIG. 14, an area AR51 equivalent to the button BU31 on the selection screen SC3 is highlighted and an image IM51 is displayed over the area AR51, whereby a state of touching the button BU31 is represented. The highlighting of the area AR51 may be, for example, halftone dot meshing display, color display, or flashing display. The image IM51 may be animation display that moves from the outside of the guidance screen SC5 and stops in a state overlapping the area AR51.

The processor 301 executes the information processing based on the substitution application AP302 in this way, whereby the computer including the processor 301 as the central part functions as a display unit.

In ACT 28 in FIG. 9, the processor 301 notifies, as an instruction in the customer terminal 300, the instruction notified from the store clerk terminal 400 to the information processing based on the smartphone POS application AP301.

In ACT 29, the processor 301 waits for a substitution end notification. If the processor 401 proceeds from ACT 15 to ACT 16 in FIG. 8 and notifies the substitution end in the store clerk terminal 400 as explained above, the processor 301 determines YES and ends the information processing based on the substitution application AP302.

If the processor 401 proceeds to ACT 16 and notifies the substitution end without executing ACT 15 in FIG. 8, the processor 301 determines YES in ACT 26 in FIG. 9 and ends the information processing based on the substitution application AP302 without performing ACT 27 and ACT 28.

In the information processing based on the smartphone POS application AP301, since the processor 301 is in a state of waiting for an instruction on the target screen, the processor 301 determines that an instruction notified by the information processing based on the substitution application AP302 is performed and proceeds to processing corresponding to the instruction. As a result, in the virtual POS server 2, the processor 21 executes the registration processing or the accounting processing according to an instruction by the store clerk in the store clerk terminal 400. However, in a state in which, in the store clerk terminal 400, the processor 401 does not execute the information processing based on the store clerk terminal application AP401, the processor 21 executes the registration processing or the accounting processing according to an instruction of the customer in the customer terminal 300 without considering the instruction of the store clerk in the store clerk terminal 400. A state in which the processor 401 does not execute the information processing based on the store clerk terminal application AP401 in this way is equivalent to a first operation mode. A state in which the processor 401 executes the information processing is equivalent to a second operation mode.

Thereafter, the display on the touch panel 304 of the customer terminal 300 is updated by the information processing based on the smartphone POS application AP301 to reflect a processing result in the virtual POS server 2.

As explained above, with the transaction processing system in this embodiment, it is possible to perform, according to an instruction of the store clerk by operation of the store clerk terminal 400, substituting for the customer, an instruction that should be performed by operation by the customer in the customer terminal 300. In this way, the operation for the instruction substitution is informed to the customer by displaying the guidance screen SC5 in the customer terminal 300. Accordingly, the customer can confirm the operation for the instruction performed by the store clerk substituting for the customer.

At this time, the operation by the store clerk is performed in the store clerk terminal 400 and the display of the guidance screen SC5 is performed in the customer terminal 300. Therefore, since the store clerk need not perform the operation such that the customer can easily see the operation, a burden on the store clerk does not increase excessively. Since the customer does not look into the operation by the store clerk, the customer can easily confirm the operation.

Various modified implementations of this embodiment are possible as explained below.

The transaction processing system may be realized as a transaction processing system that provides a cart POS service, a self-settlement service, a semi-self-settlement service, or the like. If the cart POS service is provided, the first apparatus is, for example, a cart terminal. If the self-settlement service is provided, the first apparatus is, for example, a self-service POS terminal. If the semi-self-settlement service is provided, the first apparatus is, for example, a semi-self-service accounting machine.

The processor 31 of the mobile controller 3 or a processor included in another server may execute information processing similar to the information processing illustrated in FIGS. 7 and 8 while using the store clerk terminal 400 as a user interface device.

The processor 31 of the mobile controller 3 or a processor included in another server may execute information processing similar to the information processing illustrated in FIG. 9 while using the customer terminal 300 as a user interface device.

In the customer terminal 300, the processor 301 may execute all or a part of the registration processing and the accounting processing. In this case, the computer including the processor 301 as the central part has a function of the processing unit.

The processor 31 of the mobile controller 3 or a processor included in another server may execute all or a part of the registration processing and the accounting processing. In this case, a computer including the processor 31 or a processor included in the other server as a central part has a function of the processing unit.

The processor 31 of the mobile controller 3 or the processor included in the other server may execute display of at least any one of the confirmation screen SC2, the in-substitution screen SC4, and the guidance screen SC5. In this case, a computer including the processor 31 or the processor included in the other server as a central part has a function of the display unit, the first informing unit, or the second informing unit.

In at least one embodiment, the substitution state is released if one instruction is performed in the store clerk terminal 400. Consequently, it is possible to prevent the store clerk from easily continuing to perform, substituting the customer, an instruction that the customer should originally perform. The substitution state may be continued until the release is instructed in the customer terminal 300 or the store clerk terminal 400 to enable the store clerk to continuously perform a plurality of instructions substituting for the customer.

Concerning the various notifications between the customer terminal 300 and the store clerk terminal 400, the terminal ID of the notification source may not be included in the notification data transmitted from the notification source. In this case, for example, in the mobile controller 3, the processor 31 only has to identify the notification source using a protocol of communication with the notification source.

The terminal ID of the transmission source and the terminal ID of the notification destination of the notification data for notifying the substitution start may be correlated and managed in the mobile controller 3. The terminal ID of the notification destination may not be included in other notification data transmitted from the notification source.

A part or all of the functions realized by the processors 11, 21, 31, 301, and 401 according to the information processing can also be realized by hardware for executing information processing not based on a program such as a logic circuit. Each of the functions explained above can also be realized by combining software control with the hardware such as the logic circuit.

Several embodiments are explained above. However, the embodiments are presented as examples and are not intended to limit the scope of the disclosure. These new embodiments can be implemented in other various forms. Various omissions, substitutions, and changes can be made without departing from the spirit of the disclosure. These embodiments and modifications of the embodiments are included in the scope and the gist of the disclosure and described in claims and the scope of equivalents of the embodiments.

What is claimed is:

1. A transaction processing system that includes a first apparatus and a second apparatus and is configured to process a transaction with a customer in a store, the transaction processing system comprising:
a first receiver provided in the first apparatus and configured to input an instruction by the customer;
a second receiver provided in the second apparatus and configured to input an instruction by a store clerk in the store;
a processor configured to execute information processing for processing the transaction according to the instruction input by the first receiver or the second receiver; and
a display provided in the first apparatus and configured to, when the processor executes the information processing according to the instruction input by the second receiver, a display operation performed by the store clerk when inputting the instruction with the second receiver.

2. The system according to claim 1, wherein, in a first operation mode, the processor is configured to not execute the information processing according to the instruction input by the second receiver and, in a second operation mode, the processor is configured to execute the information processing according to the instruction input by the second receiver.

3. The system according to claim 1, wherein, in a first operation mode, the processor is configured to execute the information processing according to the instruction input by the first receiver and, in a second operation mode, the processor is configured to not execute the information processing according to the instruction input by the first receiver.

4. The system according to claim 2, further comprising a second informing processor configured to inform, in the second operation mode, the customer that the input of the instruction by the first receiver is invalid.

5. The system according to claim 1, further comprising a first informing processor configured to inform the store clerk that, when the second receiver inputs a predetermined instruction, the predetermined instruction should be input by the first receiver.

6. The system according to claim 1, wherein the processor is configured to execute the information processing according to an operation mode.

7. The system according to claim 1, wherein the first apparatus comprises a handheld device.

8. The system according to claim 1, wherein the first apparatus is configured to input instructions from the customer to provide registration processing.

9. The system according to claim 1, wherein the information processing includes at least one of registration processing or accounting processing.

10. The system according to claim 1, wherein the first apparatus comprises a customer terminal.

11. The system according to claim 1, wherein the second apparatus comprises a clerk terminal.

12. The system according to claim 1, wherein the display comprises a touch panel.

13. A method of operating a transaction processing system that includes a first apparatus and a second apparatus and is configured to process a transaction with a customer in a store, the method comprising:
inputting an instruction by the customer in the first apparatus;
inputting an instruction by a store clerk in the store in the second apparatus;
executing information processing, by a processor, for processing the transaction according to the instruction input by the customer or the store clerk; and
when executing the information processing according to the instruction input by the store clerk, performing a display operation by the store clerk.

14. The method according to claim 13, wherein, in a first operation mode, the processor is configured to not execute the information processing according to the instruction input by the store clerk, and, in a second operation mode, the processor is configured to execute the information processing according to the instruction input by the store clerk.

15. The method according to claim 13, wherein, in a first operation mode, the processor is configured to execute the information processing according to the instruction input by the customer and, in a second operation mode, the processor is configured to not execute the information processing according to the instruction input by the customer.

16. The method according to claim 14, further comprising informing, in the second operation mode, the customer that the input of the instruction by the customer is invalid.

17. The method according to claim 13, wherein the first apparatus is configured to input instructions from the customer to provide registration processing.

18. The method according to claim 13, wherein the information processing includes at least one of registration processing or accounting processing.

19. The method according to claim 13, wherein the first apparatus comprises a customer terminal.

20. The method according to claim 13, wherein the second apparatus comprises a clerk terminal.
